(19) United States
(12) Patent Application Publication
(10) Pub. No.: US 2011/0137608 A1
(43) Pub. Date: Jun. 9, 2011

(54) Position Estimation Apparatuses and Systems and Position Estimation Methods Thereof

(75) Inventors: Chieh-Chih Wang, Taipei City (TW); Augustine Tsai, Taipei City (TW); Ko-Chih Wang, Yongkang Cit (TW); Yi-Kuang Ko, Taichung City (TW); Mao-Chi Huang, Dacun Township (TW); Chi-Hung Tsai, Taichung City (TW)

(73) Assignee: INSTITUTE FOR INFORMATION INDUSTRY, Taipei (TW)

(21) Appl. No.: 12/906,382

(22) Filed: Oct. 18, 2010

(30) Foreign Application Priority Data
Dec. 4, 2009 (TW) 98141477

(51) Int. Cl. G06F 15/00

(52) U.S. Cl. 702/150

(57) ABSTRACT

A position estimation system is provided, including at least one measurement unit, a plurality of evaluation units and a particle filter. The at least one measurement unit obtains a first information, wherein the first information at least includes a motion information and a corresponding noise model of a traced object. Each of the evaluation units has a corresponding evaluation model, wherein each evaluation model generates a corresponding unit displacement estimation according to the first information. The particle filter samples and generates a plurality of displacement estimations according to the unit displacement estimations and the corresponding noise models respectively.

### CROSS REFERENCE TO RELATED APPLICATIONS

This Application claims priority of Taiwan Application No. 098141477, filed on Dec. 4, 2009, the entirety of which is incorporated by reference herein.

### BACKGROUND OF THE INVENTION

1. Field of the Invention

The invention relates to position estimation systems, position estimation apparatuses and position estimation methods thereof, and more particularly to systems, apparatuses and methods thereof suitable for performing position estimation on a traced object under a situation that conventional position estimation methods was unfavorable to be applied.

2. Description of the Related Art

Global Positioning System (GPS) technology has been widely used in navigation systems of various electronic devices, such as portable devices and electronic devices in cars to receive signals from GPS satellites. Accordingly, the position of an electronic device with a GPS receiver therein, can be determined according to responsive position signals between the electronic device and the satellites. Users may also use navigation software in the electronic device for route planning and navigation.

As user requirements change, in addition to provide tracing and navigation services for cars, the GPS also provides tracing and navigation services for other objects, such as pedestrian navigation, bicycle navigation, treasures tracing and so on. In an outdoor space, the GPS may precisely provide the position information of the traced object. When in indoor place or in a place where the satellites have been interfered/covered, such as in the tunnel, shelter or the like, however, the signal may not be received due to the satellites signals may not pass through this place such that the GPS can not be operated and therefore the corresponding service can not be performed.

To continuously trace the position of the traced object when no GPS signal can be detected, inertial measurement units (IMU) are used to detect signals regarding to the movement of the traced object and a dead reckoning method is further utilized to complement the displacement information of the traced object while the GPS signal has been lost.

Generally, conventional dead reckoning method utilizes a single model to estimate the step length of the traced object to estimate potential position of the traced object. However, the dead reckoning method was unable to deal with situations that are complicated and varied, such as the walk situation of the traced object may be varied when materials of the floor or the topography has been changed. In such a case, using only single model for evaluation may be not enough. Moreover, conventional dead reckoning method utilizes a Kalman filter to estimate the step length and direction of the traced object. When the hypothesized model is incorrect, the estimation result thereof will easily be dispersed and thus errors of the estimation results can not be efficiently controlled.

### BRIEF SUMMARY OF THE INVENTION

It is therefore an objective of the invention to provide position estimation apparatuses and related position estimation methods to solve aforementioned conventional technique problems.

An embodiment of a position estimation system comprises at least one measurement unit, a plurality of evaluation units and a particle filter. The at least one measurement unit obtains a first information, wherein the first information at least includes a motion information and a corresponding noise model of a traced object. Each of the plurality of evaluation units has a corresponding evaluation model, wherein each evaluation model generates a corresponding unit displacement estimation according to the first information. The particle filter samples and generates a plurality of displacement estimations according to the unit displacement estimations and the corresponding noise models respectively.

Another embodiment of a position estimation method is provided. First, at least one measurement unit is utilized to obtain a first information, wherein the first information at least includes a motion information and a corresponding noise model of a traced object. Then, corresponding unit displacement estimations are generated according to the first information and a plurality of evaluation units, wherein each of the evaluation units has a corresponding evaluation model and each of the evaluation models generates a corresponding unit displacement estimation according to the first information. Thereafter, a particle filter is utilized to sample and generate a plurality of displacement estimations according to the unit displacement estimations and the corresponding noise models respectively.

Another embodiment of a position estimation apparatus comprises a shell, a positioning unit, at least one measurement unit, a plurality of evaluation units and a particle filter. The positioning unit is disposed inside the shell for receiving a position signal and utilizing the position signal to provide a position information of the apparatus. The at least one measurement unit is disposed inside the shell for obtaining a first information, wherein the first information at least includes a motion information and a corresponding noise model of a traced object. The plurality of evaluation units are disposed inside the shell and coupled to the at least one measurement unit, each of which having a corresponding evaluation model, wherein each evaluation model generates a corresponding unit displacement estimation according to the first information. The particle filter is disposed inside the shell and coupled to the evaluation units and the positioning unit for generating a plurality of displacement estimations according to the unit displacement estimations and the corresponding noise models respectively, determining a displacement of the traced object according to the evaluation displacements and determining a position prediction of the traced object according to the displacement of the traced object and the position information.

Position estimation methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a position estimation system of the invention;

FIG. 2A is a schematic diagram illustrating an embodiment of a step detection method of the invention;

FIG. 2B is a schematic diagram illustrating an embodiment of an acceleration measurement result with respect to FIG. 2A of the invention;

FIG. 3 is a schematic diagram illustrating an embodiment of a correlation diagram of a step length and a step frequency of the invention;

FIG. 4 is a flowchart illustrating an embodiment of a position estimation method of the invention; and

FIG. 5 is a schematic diagram illustrating an embodiment of a portable electronic appliance of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide position estimation systems, apparatuses and methods thereof such that when in a place where no GPS signal can be detected (e.g. in the indoor place), measurement information of a traced object (e.g. a pedestrian, a child, a bicycle, a wheelchair, a vehicle, treasures and so on) can be first obtained by using measurement device(s), and the measurement information and a plurality of evaluation units are then utilized to determine a displacement information of the traced object (including a distance and a direction information thereof). The displacement information may further be combined with previously recorded or measured position information to determine an estimation position for the traced object. Furthermore, when any GPS signal has once again detected (e.g. in the outdoor place), the system and the apparatus of the invention may utilize the position information obtained by the GPS signal to correct the position result of the traced object.

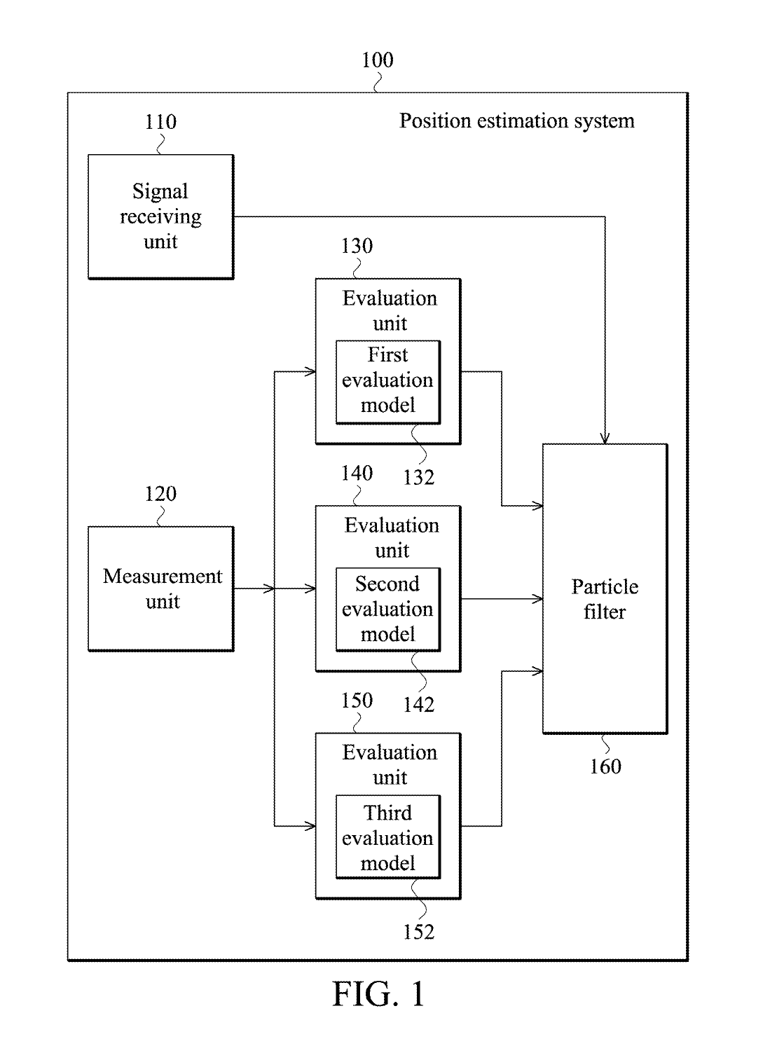

FIG. 1 is a schematic diagram illustrating an embodiment of a system 100 of the invention. The system 100 may be configured on a portable device, such as a mobile phone, a PDA, a GPS navigation device or a laptop computer, for personal carry by a traced object (e.g. a pedestrian). The system 100 at least comprises a measurement unit 120, at least one evaluation units 130-150 and a particle filter 160. The measurement unit 120 is used for obtaining a first information, wherein the first information at least includes a motion information and a corresponding noise model of a traced object. For example, the measurement unit 120 may include inertial measurement units, such as an electronic compass and an accelerator, wherein the electronic compass may be used to obtain a moving direction of the traced object and the accelerator may be used to obtain an acceleration of the traced object. The obtained moving direction and acceleration of the traced object may further be used to estimate a moving distance for the traced object. Furthermore, the measurement unit 120 may further comprise a gyroscope for obtaining angular variation information of the traced object. With the gyroscope, the moving direction of the traced object may be obtained more precisely.

Noise models are used for describing a potential noise distribution when the measurement unit 120 obtains the motion information. The noise models may be different according to the types and the accuracies of the measurement unit used. In practice, the noise model is often described as a normal distribution with an average value “zero”.

In other embodiments, the measurement unit 120, the evaluation units 130-150 and the particle filter 160 may be separately configured on different devices and may communicate with each other via a wired or wireless communication network. For example, the measurement unit 120 may be configured on a portable device while the evaluation units 130-150 and the particle filter 160 may be configured on a computer system or a server. In addition, in some embodiments, the measurement unit 120 may further be devices capable of detecting the displacement of the traced object, such as laser ranger, active laser scanner, sonar-system or any kinds of wireless position signal receiving modules, for estimating the motion information of the traced object. For example, the measurement unit 120 may be a receiving module that is capable of receiving the triangular position signal form wireless base stations for receiving the triangular position signal to obtain the position of the traced object in different times to estimate the moving distance and the moving direction of the traced object.

In some embodiments, the system 100 may further comprise a signal receiving unit 110 to receive GPS satellite signals or signals from any kinds of wireless position signal receiving modules to obtain a corresponding position signal. The obtained position signal may then be used to calculate current position of the traced object.

Each of the evaluation units 130-150 may have a corresponding evaluation model, wherein each evaluation model may generate a corresponding unit displacement estimation according to the first information. As shown in FIG. 1, each of the evaluation units 130-150 is coupled to the measurement unit 120 for respectively receiving the first information that is obtained by the measurement unit 120 and contains the motion information of the traced object.

In other embodiments, each of the evaluation units 130-150 may further have a weight, and the particle filter 160 may further determine the displacement of the traced object according to the weight of each of the evaluation units 130-150 and the displacement estimation corresponding thereto. The weights of the evaluation units may be adjustable, e.g. when the signal receiving unit 110 continuously receives position signals and obtains next position information according to the position signal and the system 100 may also generate corresponding unit displacement estimations according to the evaluation units 130-150, the particle filter 160 may further calculate differences between the next position information and each of the evaluation units 130-150, and then the calculated differences can be used to modify the evaluation model of each of the evaluation units 130-150 or modify the weight of each of the evaluation units 130-150 so as to improve the prediction accuracy of the displacement estimation.

The particle filter 160 is mainly used to generate a plurality of displacement estimations according to the unit displacement estimations determined by the evaluation units 130-150 and the corresponding noise models respectively. Further, the particle filter 160 may then determine the displacement of the traced object according to the generated displacement estimations. The particle filter 160 may also determine the displacement of the traced object according to the weight of each of the evaluation units 130-150 and the displacement estimation corresponding thereto when the weights of the evaluation units 130-150 are different from each other.

In other embodiments, for the case that the system 100 is with a signal receiving unit 110, the particle filter 160 may further determine a plurality of position predictions of the traced object according to the displacement estimations and the position information or may first determine a displacement of the traced object according to the displacement estimations and then determines a position prediction of the traced object according to the displacement of the traced object and the position information.

Moreover, either the GPS satellite position signal or other kinds of wireless position signal will have an error model so that the particle filter 160 may further calculate the displacement and an error distribution corresponding to the traced object according to the unit displacement estimations of the evaluation units 130-150 and the noise model thereof, and then modify the predicted position information according to the position signal and the error model thereof when determining the displacement of the traced object. For example, the weight of the position signal and the weight of the displacement of the traced object can be determined according to the position signal and the error model thereof and the displacement of the traced object and the noise model thereof. Therefore, when calculating the displacement of the traced object, the particle filter 160 may perform the calculation by using the determined weights, and may modify the weight of the position signal and the weight of the displacement of the traced object accordingly when the position prediction of the traced object is to be modified.

As shown in FIG. 1, the measurement unit 120 may continuously detect and obtain a next first information and the evaluation units 130-150 may further generate corresponding next unit displacement estimations according to the next first information such that the particle filter 160 may further generate a plurality of next displacement estimations according to the next unit displacement estimations and the noise models corresponding thereto to determine a next displacement of the traced object and then determines a next position prediction of the traced object according to the next displacement of the traced object and the position prediction of the traced object previously determined.

In other embodiments, the system 100 may further comprise a storage unit (not shown in FIG. 1) for recording the position information and the position prediction of the traced object. The storage unit may further record an electronic map and the system 100 may further comprise a display unit (not shown in FIG. 1) for displaying the electronic map and the position prediction of the traced object or the electronic map and the position information, etc. For example, the storage unit may be any kinds of known memories, hard disks, portable disks or other storage mediums and the display unit may be any kinds of monitors or display devices such as the LCD or the digital display.

For explanation, one specific embodiment is illustrated in the following, and those skilled in the art will understand that this specific embodiment is used for explanation only but the invention is not limited thereto. In this embodiment, the traced object is a pedestrian, the measurement unit 120 comprises an electronic compass and an accelerator, the measured motion information comprises the moving direction and the acceleration of the pedestrian and the unit displacement estimation is the unit moving distance and direction of the traced object, i.e. the step length information and the direction information of the pedestrian.

Each of the evaluation units 130-150 respectively comprises a predefined step length evaluation model for performing an estimation on the motion information using the different step length evaluation models to generate corresponding step length estimations respectively. It is to be noted that, for explanation, only three evaluation units 130-150 and specific evaluation models are used in this embodiment, but the invention is not limited thereto. In other words, the number of the evaluation units and the number of the evaluation models used thereof can be adjusted according to the actual requirement and environment.

In this embodiment, the system may further comprise a timer for recording of time and one of the evaluation units 130 may have a step length evaluation model (i.e. a first evaluation model 132), based on a step detection and a step frequency determination, which first determines a step detection of the pedestrian based on the acceleration variance from zero measured along the vertical direction, obtains a step frequency of the pedestrian according to the step detection and a time period corresponding to the step, and then calculates the step frequency to obtain a step length information of the pedestrian.

The step length evaluation model based on the step detection and the step frequency determination performs the step length estimation by using a fact that the step length is positive correlated to the step frequency, and the formula therefor can be defined as below:

Step_length=A*Step_frequency+B, (1)

where values of A and B are constant which may be varied for different users.

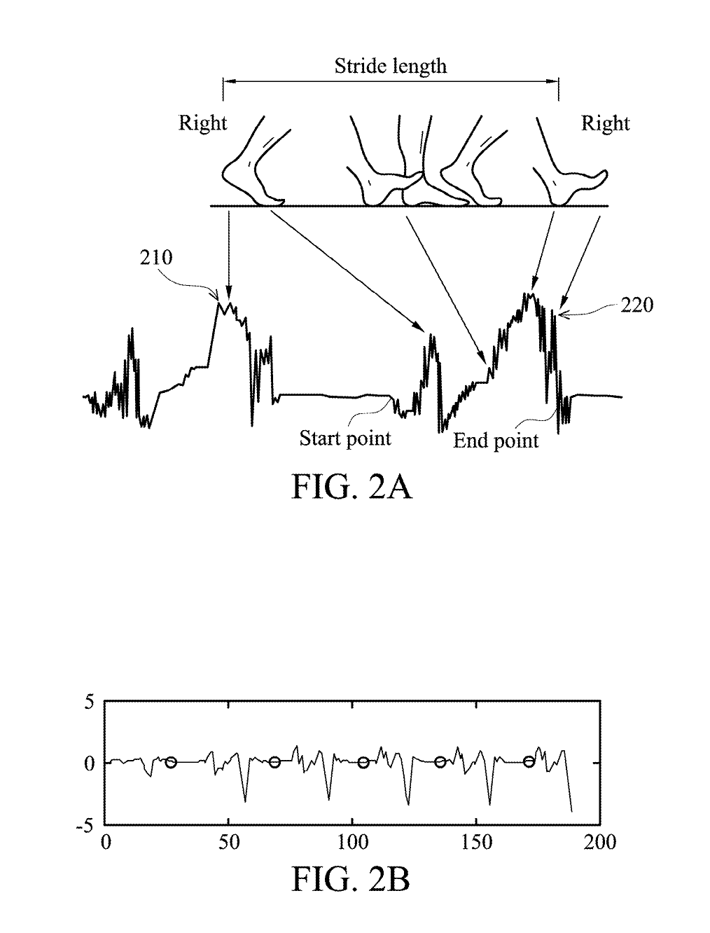

Please refer to FIGS. 2A and 2B. FIG. 2A is a schematic diagram illustrating an embodiment of a step detection method of the invention and FIG. 2B is a schematic diagram illustrating an embodiment of an acceleration measurement result with respect to FIG. 2A of the invention. It is found by experiment that they are specific for the rule and frequency of the feet move ways and the feet positions touched on the ground when people is walking. When the sole of the foot of a person is fully touched on the ground, the acceleration along the vertical direction is zero (as shown in 210 and 220 of FIG. 2A). Therefore, when detecting the acceleration of the body of the pedestrian, the acceleration at this moment can be used to determine whether a step has been generated. That is, whether a step is generated can be determined by a determination of whether the variation in the acceleration along the vertical direction from zero is enough to determine a step detection of the pedestrian.

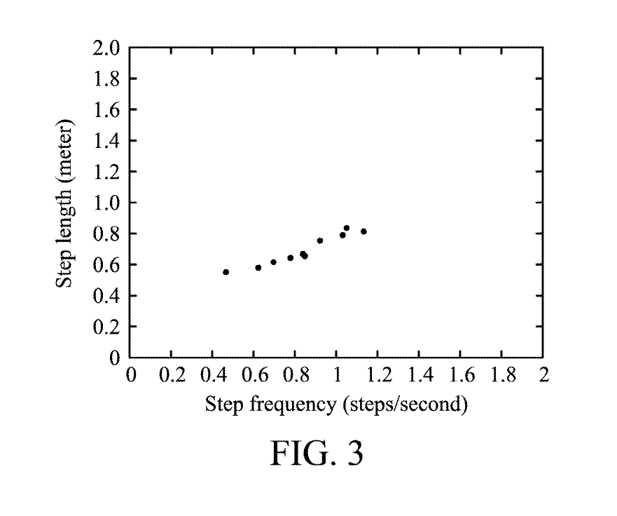

Moreover, distance measuring equipments, such as a laser ranger, may also be utilized to record the walk information for a pedestrian under test and to mark the position of each step when it is touched on the ground to construct a step length model. Please refer to FIG. 3, which is a schematic diagram illustrating an embodiment of a correlation diagram of a step length and a step frequency of the invention.

Evaluation unit 140 may have a step length evaluation model (i.e. a second evaluation model 142), based on an acceleration determination, which determines a step detection of the pedestrian based on the acceleration variance from zero measured in the vertical direction and estimates the step length information according to the maximum and minimum of acceleration between two steps. If Aₘₐₓ and Aₘᵢₙ respectively represent the maximum and minimum of acceleration between two steps and K represents a constant, the formula for the step length evaluation model based on an acceleration determination can be defined as below:

Step_length≅\sqrt{Aₘₐₓ−Aₘᵢₙ}×K, (2)

where the value of the constant K may be varied for different users.

The first information may further comprise a height of the pedestrian and one of the evaluation units 150 may have a step length evaluation model (i.e. a third evaluation model 152), based on the height of the pedestrian, which estimates the step length information according to the height of the pedestrian. As the step length of a pedestrian will be affected by the height thereof, the formula for the step length evaluation model based on the height information of the pedestrian can be defined as below:

Step_length=A*Height+B, (3)

where values of A and B are constant which may be varied for different users.

Therefore, the first information obtained by each of the measurement units 120 can be used in the specific models of the evaluation units 130-150 to generate the corresponding step length estimation results respectively.

The particle filter 160 is coupled to the evaluation units 130-150 and the signal receiving unit 110 and generates a plurality of potential particle displacements as the plurality of displacement estimations according to the motion information and the corresponding noise models of the evaluation units 130-150, determines the weight of the position signal and the weight of the displacement of the traced object according to the position signal and the error model thereof and the displacement of the traced object and the corresponding error distribution to modify the position prediction of the traced object. The position signal may further comprise an error model and the particle filter 160 further generates, when determining the displacement of the traced object, an error distribution corresponding to the displacement of the traced object according to the unit displacement estimations and the corresponding noise models and modifies the predicted position information of the traced object according to the position signal and the error model thereof and the displacement of the traced object and the error distribution thereof. It is to be noted that although a particle filter that is capable of simultaneously processing outputs of multiple models is utilized to process multiple step length estimation results of multiple evaluation units in this embodiment, but the invention is not limited thereto. In this embodiment, the particle filter 160 can be utilized to process the step length estimation results generated by the evaluation units 130-150. Particle filtering is an optimized non-linear filtering method, which introduces the random search concept used in its state space into the conventional filtering field. The kernel concept of the particle filtering algorithm is to utilize a number of random samples (“particles”) to represent a posterior probability density of random variants of the system and thus can obtain an optimized approximation solution that is the physical model based rather than performing an optimal filtering on the approximation model. In this embodiment, by the particle filter, a number of potential step length evaluation models can be easily utilized to estimate the walk position of the pedestrian and it can gain certain tolerance under limitation that precisely parameters for each model may not be obtained, thus suitable for tracking the dynamically changed walking status of the pedestrian.

In this embodiment, the particle filter may comprise two stages: a prediction stage and an update stage for particle filtering. In the prediction stage, signals gathered by the measurement unit 120 will be applied to the multiple models of the evaluation units 130-150 to generate a lot of the particles representing the potential displacement distribution and the generated particles will then be utilized to determine the position of the pedestrian. In the update stage, after the signal receiving unit 110 has received the GPS signal, a position calculated from the received GPS signal will be utilized to update the weight of each particle and to obtain a modified position and a modified history locus. The particle filter 160 may obtain the particles by the following formula:

For the prediction stage:

B⁻(s)=∫P(s|m,x′)B(x′)dx, (4)

wherein B(.) and B⁻(.) respectively represent the confidence level before and after the prediction, m represents the used model, P(.) represents the probability, s represents current state and x′ represents a previous state;

For the update stage:

ω=αP(o|s), (5)

wherein α represents the weight before updating, o represents the observation value, P(.) represents the probability and ω represents the weight after updating.

In order to update the estimated position with reference to the GPS position information, in this embodiment, a re-sampling step is further performed. The re-sampling step can be performed by retrieving L new particles from current M particles (L≦M) using the weights of the M particles and the proportion the weights, setting the weight of each of the L new particles to be 1/L, and then estimating potential particle distribution by the formula (5) using the new particles and weights. Accordingly, the format of the estimated particle distribution can therefore be used to determine actual position of the pedestrian. Description of operation of the particle filter will be detailed in below.

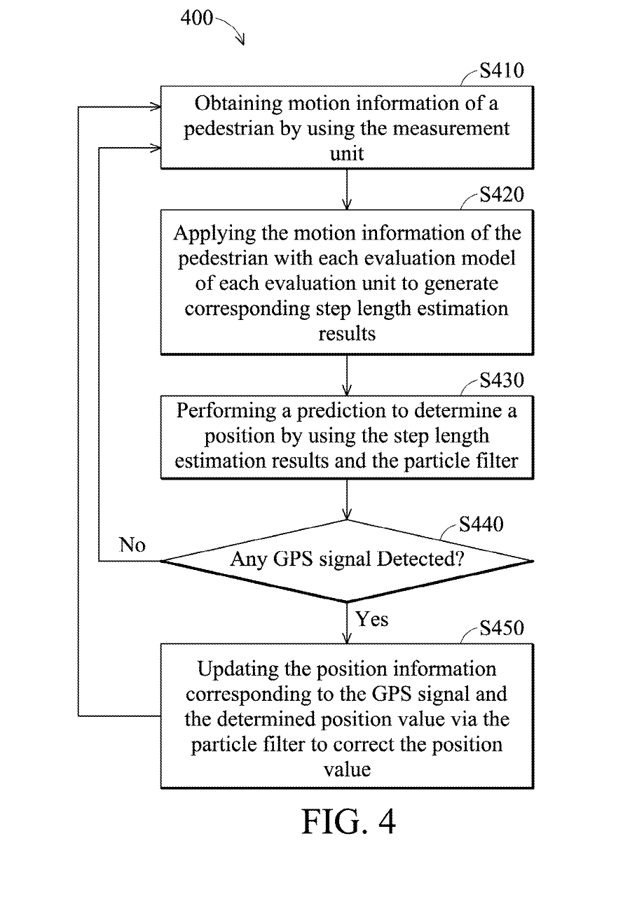

FIG. 4 is a flowchart illustrating an embodiment of a position estimation method of the invention. The position estimation method can be performed by the position estimation system 100 shown in FIG. 1.

First, in step S410, motion information of a pedestrian including the moving direction and the acceleration is obtained by using the measurement unit 120. Thereafter, in step S420, the motion information of the pedestrian obtained by the measurement unit 120 is applied with the evaluation models 132, 142 and 152 of the evaluation units 130, 140 and 150 to perform a step length evaluation to generate corresponding step length estimation results respectively. The step length estimation results may comprise a step length information and a direction information of the pedestrian, wherein a step detection step is further performed to detect a step based on a determination of whether there is a significant variance of acceleration along the vertical direction. As aforementioned, the evaluation unit 130 may utilize the step frequency to estimate the step length and obtains the direction information using the step length evaluation model based on the step detection and the step frequency determination, the evaluation unit 140 may utilize a maximum acceleration and a minimum acceleration between two steps to estimate the moving step length and direction information using the step length evaluation model based on an acceleration determination, while the evaluation unit 150 may utilize the height information of the pedestrian to estimate the moving step length information using the step length evaluation model based on the height information of the pedestrian. After the step length information and the direction information of the pedestrian are estimated by using the evaluation units 130-150, in step S430, the step length estimation results generated by the evaluation units 130-150 are used by the particle filter 160 to perform a prediction to determine a position of the pedestrian. Meanwhile, as the particle filter 160 is in the prediction stage, the step length and the direction information contained in all of the step length estimation results can be added with a proper noise and then be applied on the aforementioned formula (4) to perform a prediction to generate potential positions of the particles by modifying current positions of the particles using current information. Therefore, a position estimation value of the pedestrian can be obtained according to the generated potential positions of the particles. Thereafter, in step S440, it is determined that whether any GPS signal has been detected. If no available GPS signal has been detected by the signal receiving unit 110, which means that the user may still in the indoor, steps S410 to S440 will be repeated to continuously estimate the position of the user using the particle filter 160 and the multiple models of the evaluation units 130-150.

If any available GPS signal has been detected by the signal receiving unit 110 (Yes in step S440), in step S450, a position information corresponding to the detected GPS signal and the determined position estimation value will further be updated through the particle filter 160 to correct the position estimation value. For example, the particle filter 160 may use the position information corresponding to the detected GPS signal as an observation point and a mean of the two-dimensional Gauss distribution, and then uses this distribution as a basis for updating weights of each of the particles to generate a new weight for each particle and re-samples all of the particles according to the new weights to obtain a corrected position value. Thus, larger tolerance for modeling errors can be provided.

In one embodiment, the position estimation system of the invention may further be embedded into a portable electronic appliance (e.g. a mobile phone, a navigation device or the like) with a GPS module for providing indoor/outdoor position information of a pedestrian and further providing a pedestrian navigation system using map data.

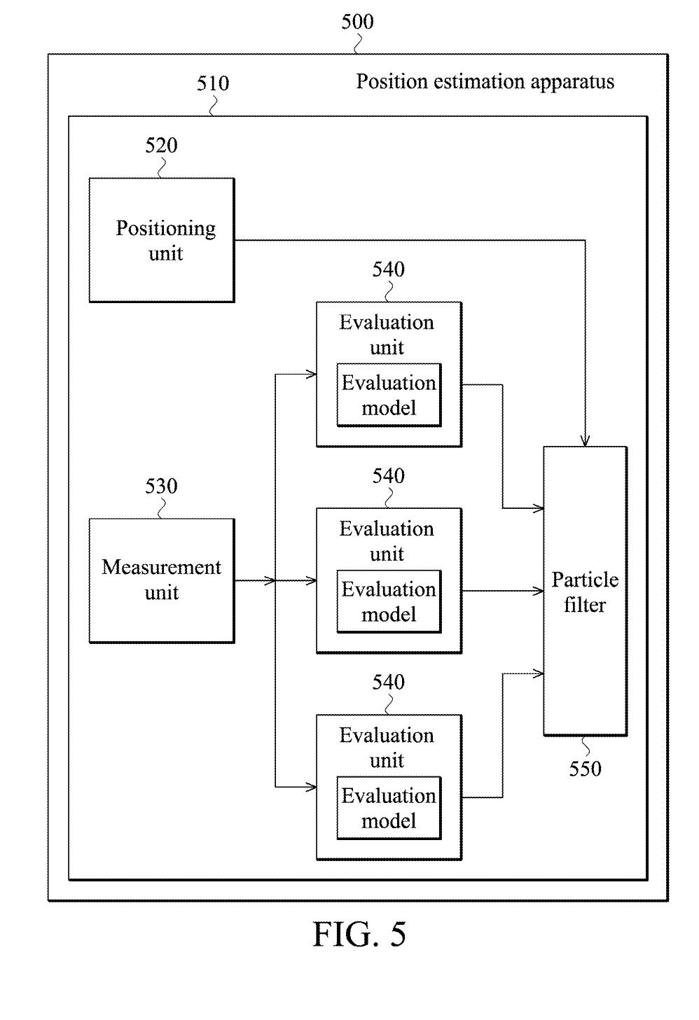

FIG. 5 is a schematic diagram illustrating an embodiment of a position estimation apparatus 500 of the invention. As shown in FIG. 5, the position estimation apparatus 500 at least comprises a shell 510, a positioning unit 520, at least one measurement unit 530, a plurality of evaluation units 540 and a particle filter 550, wherein the processing unit 520, e.g. a GPS module, may calculate a current position of the electronic apparatus 500 based on received GPS satellite signals and then performs a navigation function using a map data. The positioning unit 520 is disposed inside the shell 510 and is used for receiving a position signal and providing a position information of the apparatus 500 according to the received position signal. The at least one measurement unit 530 which is disposed inside the shell 510 is used for obtaining a first information, wherein the first information at least includes a motion information and a corresponding noise model of a traced object. The evaluation units 540, which are disposed inside the shell 510 and coupled to the measurement unit 530, have multiple evaluation models, each of which having a corresponding evaluation model. Each evaluation model may generate a corresponding unit displacement estimation according to the first information. The particle filter 550, which is disposed inside the shell 510 and is coupled to the positioning unit 520 and the evaluation units 540, may sample and generate a plurality of displacement estimations according to the unit displacement estimations and the corresponding noise models respectively, determine a displacement of the traced object according to the generated displacement estimations and further determine a position prediction of the traced object according to the displacement and the position information of the traced object. The apparatus 500 may further comprise a storing unit (not shown), which is disposed out of the shell 510 and coupled to the positioning unit 520 and the particle filter 550, for recording the position information and the position prediction of the traced object and an electronic map data. The apparatus 500 may further comprise a display unit (not shown), which is disposed out of the shell 510 and is coupled to the particle filter 550, for displaying the electronic map and the position prediction of the traced object on the electronic map. Therefore, the apparatus 500 may utilize aforementioned position estimation method of the invention to provide position information and perform a pedestrian navigation using the map data when the positioning unit 520 can not receive any GPS signals.

In summary, with the position estimation systems, apparatuses and methods of the invention, in an environment where no GPS signal can be detected when the position signal is lost, information from the measurement units or other measurement signals can be analyzed and can be utilized to determine current position and a moving path of a tracing object (e.g. a user) so as to estimate actual position of the user, thus providing larger tolerance for modeling errors and making the robustness of the system. Moreover, models applied or information sources within the multiple models structure of the invention can easily be replaced to meet any scene requirement based on the actual environment and application requirements so as to achieve optimal accuracy.

Position estimation systems and methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention (e.g., use a ring buffer). Therefore, the scope of the present invention shall be defined and protected by the following claims and their equivalents.

What is claimed is:

1. A position estimation system, comprising:
at least one measurement unit, obtaining a first information, wherein the first information at least includes a motion information and a corresponding noise model of a traced object;
a plurality of evaluation units, each of which having a corresponding evaluation model, wherein each evaluation model generates a corresponding unit displacement estimation according to the first information; and
a particle filter, sampling and generating a plurality of displacement estimations according to the unit displacement estimations and the corresponding noise models respectively.

2. The position estimation system of claim 1, wherein the unit displacement estimation is the unit moving distance and direction of the traced object.

3. The position estimation system of claim 1, further comprising a signal receiving unit for receiving a position signal and obtaining a position information according to the position signal, wherein the particle filter further samples a plurality of position predictions of the traced object according to the displacement estimations and the position information.

4. The position estimation system of claim 1, further comprising a signal receiving unit for receiving a position signal and obtaining a position information according to the position signal, wherein the particle filter further determines a displacement of the traced object according to the displacement estimations and determines a position prediction of the traced object according to the displacement of the traced object and the position information.

5. The position estimation system of claim 4, wherein the signal receiving unit further continuously receives a next position signal and obtains a next position information according to the next position signal, wherein the particle filter further respectively modifies each of the corresponding evaluation models according to the unit displacement estimation generated by the corresponding evaluation unit and the next position information.

6. The position estimation system of claim 4, wherein the position signal further comprises an error model, and when determining the displacement of the traced object, the particle filter further generates an error distribution corresponding to the displacement of the traced object according to the unit displacement estimation and the noise models, and modifies the predicted position information according to the position signal and the error model thereof and the displacement of the traced object and the error distribution thereof.

7. The position estimation system of claim 4, wherein the at least one measurement unit further continuously obtains a next first information; the evaluation units further generate corresponding next unit displacement estimations according to the next first information; and the particle filter further generates a plurality of next displacement estimations according to the next unit displacement estimations and the noise models corresponding thereto and determines a next displacement of the traced object based on the next displacement estimations, and determines the next position prediction of the traced object according to the next displacement of the traced object and the position prediction of the traced object.

8. The position estimation system of claim 1, wherein the particle filter further generates a plurality of potential particle displacements as the plurality of displacement estimations according to the motion information and the corresponding noise model.

9. A position estimation apparatus, comprising:
a shell;
a positioning unit disposed inside the shell, receiving a position signal and utilizing the position signal to provide a position information of the apparatus;
at least one measurement unit disposed inside the shell, obtaining a first information, wherein the first information at least includes a motion information and a corresponding noise model of a traced object;
a plurality of evaluation units disposed inside the shell and coupled to the at least one measurement unit, each of which having a corresponding evaluation model, wherein each evaluation model generates a corresponding unit displacement estimation according to the first information; and
a particle filter disposed inside the shell and coupled to the evaluation units and the positioning unit, generating a plurality of displacement estimations according to the unit displacement estimations and the corresponding noise models respectively, determining a displacement of the traced object according to the displacement estimations and determining a position prediction of the traced object according to the displacement of the traced object and the position information.

10. The position estimation apparatus of claim 9, wherein the unit displacement estimation is the unit moving distance and direction of the traced object.

11. The position estimation apparatus of claim 9, wherein the position signal further comprises an error model and when determining the displacement of the traced object, the particle filter further generates an error distribution corresponding to the displacement of the traced object according to the unit displacement estimations and the noise models and modifies the predicted position information according to the position signal and the error model thereof and the displacement of the traced object and the error distribution thereof.

12. The position estimation apparatus of claim 9, wherein the at least one measurement unit further continuously obtains a next first information; the evaluation units further generate corresponding next unit displacement estimations according to the next first information; and the particle filter further generates a plurality of next displacement estimations according to the next unit displacement estimations and the noise models corresponding thereto and determines a next displacement of the traced object based on the next displacement estimations and determines the next position prediction of the traced object according to the next displacement of the traced object and the position prediction of the traced object.

13. The position determination apparatus of claim 9, further comprising:
a storage unit disposed inside the shell and coupled to the positioning unit and the particle filter for recording the position information and the position prediction of the traced object and an electronic map; and
a display unit disposed outside the shell and coupled to the particle filter for displaying the electronic map and the position prediction of the traced object.

14. The position estimation apparatus of claim 9, wherein the particle filter further generates a plurality of potential particle displacements as the plurality of displacement estimations according to the motion information and the corresponding noise model.

15. A position estimation method, comprising:
utilizing at least one measurement unit to obtain a first information, wherein the first information at least includes a motion information and a corresponding noise model of a traced object;
generating corresponding unit displacement estimations according to the first information and a plurality of evaluation units, wherein each of the evaluation units has a corresponding evaluation model and each of the evaluation models generates a corresponding unit displacement estimation according to the first information; and
utilizing a particle filter to sample and generate a plurality of displacement estimations according to the unit displacement estimations and the corresponding noise models respectively.

16. The method of claim 15, further comprising:
receiving a position signal through a signal receiving unit and obtaining a position information of the traced object according to the position signal, wherein
the position signal further comprises an error model and when determining the displacement of the traced object, the particle filter further generates an error distribution corresponding to the displacement of the traced object according to the unit displacement estimations and the noise models and modifies the predicted position information according to the position signal and the error model thereof and the displacement of the traced object and the error distribution thereof.

17. The method of claim 16, wherein the particle filter further determines the weight of the position signal and the weight of the displacement of the traced object according to the position signal and the error model thereof and the displacement of the traced object and the noise model thereof so as to modify the predicted position information.

18. The method of claim 15, further comprising:
utilizing the at least one measurement unit to continuously obtain a next first information;
generating a corresponding next unit displacement estimation according to the evaluation units and the next first information; and
utilizing the particle filter to generate a plurality of next displacement estimations according to the next unit displacement estimations and the noise models corresponding thereto and determine a next displacement of the traced object based on the next displacement estimations and determine the next position prediction of the traced object according to the next displacement of the traced object and the position prediction of the traced object.

19. The method of claim 15, further comprising
providing a storage unit for recording the position information and the position prediction of the traced object and an electronic map; and
providing a display unit for displaying the electronic map and the position prediction of the traced object.

20. The method of claim 15, wherein the particle filter further generates a plurality of potential particle displacements as the plurality of displacement estimations according to the motion information and the corresponding noise model.
